(19) United States
(12) Patent Application Publication
(10) Pub. No.: US 2026/0004660 A1
(43) Pub. Date: Jan. 1, 2026

(54) DETERMINING THE COMPATIBILITY OF AIRSIDE INFRASTRUCTURE FOR AN AIRCRAFT

(71) Applicant: The Boeing Company, Arlington, VA (US)

(72) Inventors: Girish Naik, Ankola (IN); Evanicio C. Costa, Huntington Beach, CA (US)

(21) Appl. No.: 18/760,363

(22) Filed: Jul. 1, 2024

(51) Int. Cl. G08G 5/00

(52) U.S. Cl. CPC G08G 5/21; G08G 5/50; G08G 5/55

(57) ABSTRACT

Assessing compatibility of airport infrastructure with an aircraft model design is provided. The method comprises retrieving information about features of an airport from an airport infrastructure database and calculating, through triangulation, distances between the features of the airport. A rationale for regulatory design requirements for the features of the airport is determined. An assessment is generated based on the distances between the features, dimensions of the aircraft model, and the rationale for the regulatory requirements. The assessment identifies areas of the airport that can accommodate the aircraft model and any areas of the airport that cannot. A map of the airport is dynamically displayed in a user interface with visual indications of the areas of the airport that can accommodate the aircraft model and the areas of the airport that cannot accommodate the aircraft model to guide movement of an aircraft of the aircraft model.

### BACKGROUND INFORMATION

### Technical Field:

The present disclosure relates generally to airport operations, and more specifically to determining whether airside infrastructure suits a given aircraft.

### Background:

Airport engineers, flight crew, dispatchers, and aircraft designers determine if the airside infrastructure suits a given aircraft. Such suitability included determining whether it is safe to operate an airplane on an airfield and recommended taxi routes. Factors that influence compatibility include runway width, runway to obstacle separation, runway to taxiway separation, parking position width, etc. Current methods of assessing compatibility require extensive manual input to assess airport airside infrastructure compatibility to determine where to operate aircraft safely. This manual process is error prone and time consuming.

### SUMMARY

An illustrative embodiment provides a method for assessing compatibility of airport infrastructure with an aircraft model design. The method comprises retrieving information about features of an airport from an airport infrastructure database and calculating, through triangulation, distances between the features of the airport. A rationale for regulatory design requirements for the features of the airport is determined. An assessment is generated based on the distances between the features of the airport, dimensions of the aircraft model, and the rationale for the regulatory design requirements, wherein the assessment identifies areas of the airport that can accommodate the aircraft model and any areas of the airport that cannot accommodate the aircraft model. A map of the airport is dynamically displayed in a user interface with visual indications of the areas of the airport that can accommodate the aircraft model and the areas of the airport that cannot accommodate the aircraft model to guide movement of an aircraft of the aircraft model.

Another illustrative embodiment provides a system for assessing compatibility of airport infrastructure with an aircraft model design. The system comprises a storage device that stores program instructions and one or more processors operably connected to the storage device and configured to execute the program instructions to cause the system to: retrieve information about features of an airport from an airport infrastructure database; calculate, through triangulation, distances between the features of the airport; determine a rationale for regulatory design requirements for the features of the airport; generate an assessment based on the distances between the features of the airport, dimensions of the aircraft model, and the rationale for the regulatory design requirements, wherein the assessment identifies areas of the airport that can accommodate the aircraft model and any areas of the airport that cannot accommodate the aircraft model; and dynamically display, in a user interface, a map of the airport with visual indications of the areas of the airport that can accommodate the aircraft model and the areas of the airport that cannot accommodate the aircraft model to guide movement of an aircraft of the aircraft model.

Another illustrative embodiment provides a computer program product for assessing compatibility of airport infrastructure with an aircraft model design. The computer program product comprises a computer-readable storage medium having program instructions embodied thereon to perform the operations of: retrieving information about features of an airport from an airport infrastructure database; calculating, through triangulation, distances between the features of the airport; determining a rationale for regulatory design requirements for the features of the airport; generating an assessment based on the distances between the features of the airport, dimensions of the aircraft model, and the rationale for the regulatory design requirements, wherein the assessment identifies areas of the airport that can accommodate the aircraft model and any areas of the airport that cannot accommodate the aircraft model; and dynamically displaying, in a user interface, a map of the airport with visual indications of the areas of the airport that can accommodate the aircraft model and the areas of the airport that cannot accommodate the aircraft model to guide movement of an aircraft of the aircraft model.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram of an airport compatibility system in accordance with an illustrative embodiment;

FIG. 2 provides an example of an airport GIS chart mapping key airport geometry and features utilized by the illustrative embodiments;

FIG. 3 depicts an illustration of airport separation categories utilized by the illustrative embodiments;

FIG. 4 depicts a pictorial example of runway and taxiway separation distances utilized by the illustrative embodiments;

FIG. 5 depicts a pictorial example of taxiway and object separation distances utilized by the illustrative embodiments;

FIG. 6 depicts an example dashboard for use with the airport compatibility tool in accordance with an illustrative embodiment;

FIG. 7 depicts an example chart of available gate versus wingspan length produced by the airport compatibility tool in accordance with an illustrative embodiment;

FIG. 8 depicts an example impact assessment for a number of airports in relation to a given aircraft model;

FIG. 9 depicts an example airport map color coded for compatibility with a specific aircraft model in accordance with an illustrative embodiment;

FIG. 10 depicts a flowchart illustrating a process for assessing compatibility of airport infrastructure with an aircraft model design in accordance with an illustrative embodiment; and

FIG. 11 is an illustration of a block diagram of a data processing system in accordance with an illustrative embodiment.

### DETAILED DESCRIPTION

The illustrative embodiments recognize and take into account that airport engineers, flight crew, dispatchers, and aircraft designers determine if the airside infrastructure suits a given aircraft. Currently, no tools can assess airport infrastructure data per design standards set forth by the International Civil Aviation Organization (ICAO).

The illustrative embodiments recognize and take into account that Airport Authorities publish limited airport infrastructure data in their airport information publication system (AIP) and release it its air navigation service providers. Airport Authorities do not publish critical airport infrastructure data to determine aircraft/airport compatibility, for example, Runway to Taxiway and object separations. These parameters are imperative to decide whether an infrastructure was designed to accommodate a given aircraft.

The illustrative embodiments recognize and take into account that current methods of assessing compatibility require extensive manual input to assess airport airside infrastructure compatibility to determine where to operate aircraft safely, which can be error prone and time consuming.

The illustrative embodiments provide an airport compatibility tool that dynamically reports regarding where it is safe to operate an airplane on an airfield and displays recommended taxi routes to the flight crew. This tool's statistical and technical analysis follows Standard Recommended Practices from the International Civil Aviation Organization and Federal Aviation Administration.

The airport compatibility tool brings together aircraft ground operations, airport design, and aircraft configuration into one tool. The airport compatibility tool provided by the illustrative embodiments also reduces taxi times and fuel consumption based on optimized taxi routes and reduce CO2. This tool can be used by the airport engineering team to determine airport compatibility, product development initiatives to maximize aircraft physical configuration, and flight crew to access via moving maps areas where is safe to operate for a given aircraft configuration.

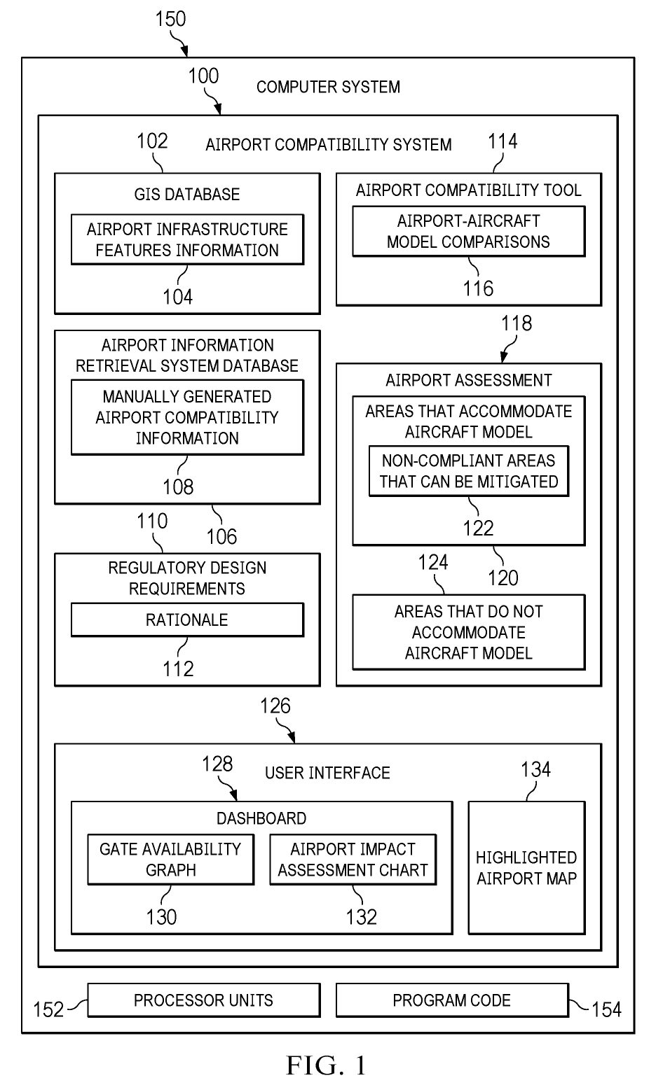

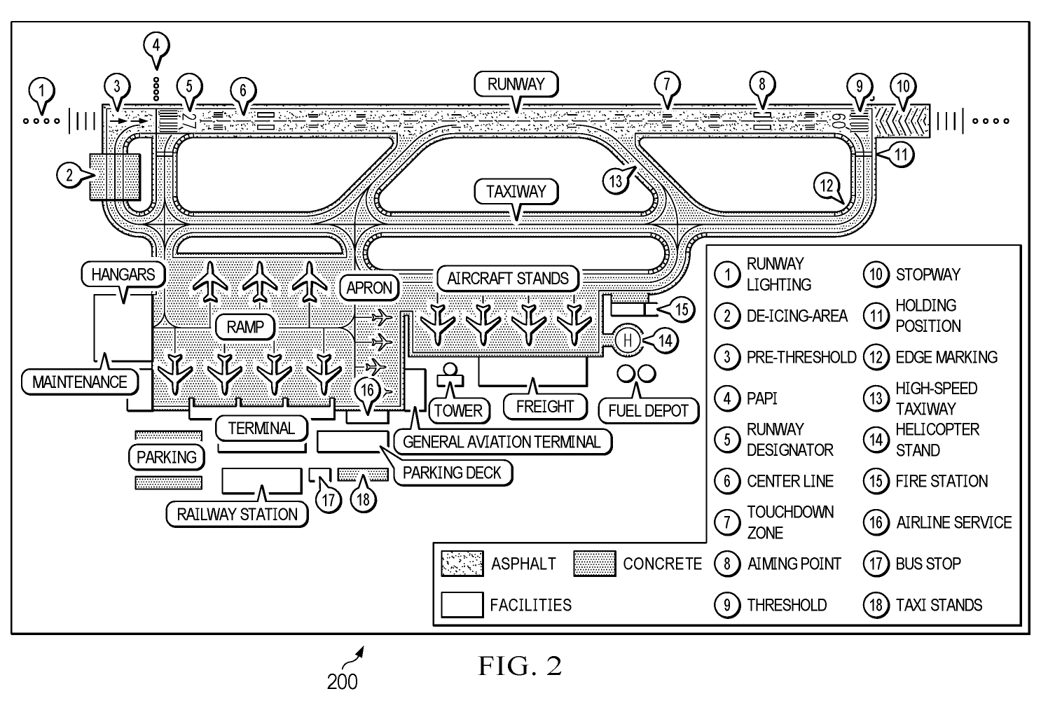

FIG. 1 is a block diagram of an airport compatibility system depicted in accordance with an illustrative embodiment. The airport compatibility system 100 makes use of an airport Geographic Information System (GIS) database 102 containing airport infrastructure features information 104 (see FIG. 2) for thousands of airports.

The airport compatibility system 100 may also utilize information from an Airport Information Retrieval System database 106 that contains manually generated airport compatibility information 108 based on previous manual evaluation methods. manually generated airport compatibility information 108 can include runway length and clearance, runway declared distances for performance calculations, runway pavement strength, historical airport weather conditions, airport services (e.g., ICAO rescue and firefighting remission), and historical airport lighting strike activity.

The manually generated airport compatibility information 108 in Airport Information Retrieval System database 106 can be fed into an automated airport compatibility tool 114 along with airport infrastructure features information 104 from airport GIS database 102.

The airport compatibility tool 114 reads the charts (e.g., chart 200 in FIG. 2) stored in the airport GIS database 102 and calculates distances between the airport features included in the charts (e.g., through triangulation). Using these data, airport compatibility tool 114 calculates a number of airport-aircraft comparisons 116 for a specific aircraft model. These comparisons might include airport general information, runway width, runway shoulder, runway-object separation, runway taxiway separation, taxiway width plus shoulder, taxiway-object separation, taxiway-taxiway separation for airports with multiple taxiways, taxilane-object separation, taxilane-taxilane separation, turnpad length and width, and apron parking position with and length.

The airport compatibility tool 114 also computes the rationale 112 behind the International Civil Aviation Organization and Federal Aviation Administration regulatory design requirements 110 and queries them against the infrastructure contained in the airport GIS database 102 to determine whether particular infrastructures can accommodate a particular aircraft model according to the physical characteristics of that aircraft. The rationale 112 behind the requirements details how the requirements were determined. The analysis of the rationale behind the requirements may reveal situations that can accommodate an aircraft type that might not otherwise be allowed under a simple blight line rule.

The airport compatibility tool 114 generates an airport assessment 118 based on the airport-aircraft comparisons 116 in light of the rationale 112 behind the regulatory design requirements 110. The airport assessment 118 identifies areas within the airport that accommodate the specific aircraft model 120 and areas that do not accommodate the aircraft model 124. By using the rationale 112 behind the regulatory design requirements 110, airport assessment 118 can identify non-compliant areas within the airport that can be mitigated 122, i.e. these areas of an airport are not strictly compliant with regulations for an aircraft model, but this non-compliance can be mitigated through adjustments in operational procedures and/or minor infrastructure retrofitting. Such non-compliant areas can be included among the areas that accommodate the aircraft model 120.

In contrast, the areas that do not accommodate the aircraft model 124 would require significant changes to operational procedures or significant structural changes to the airport infrastructure and/or the aircraft itself to accommodate the aircraft model in question.

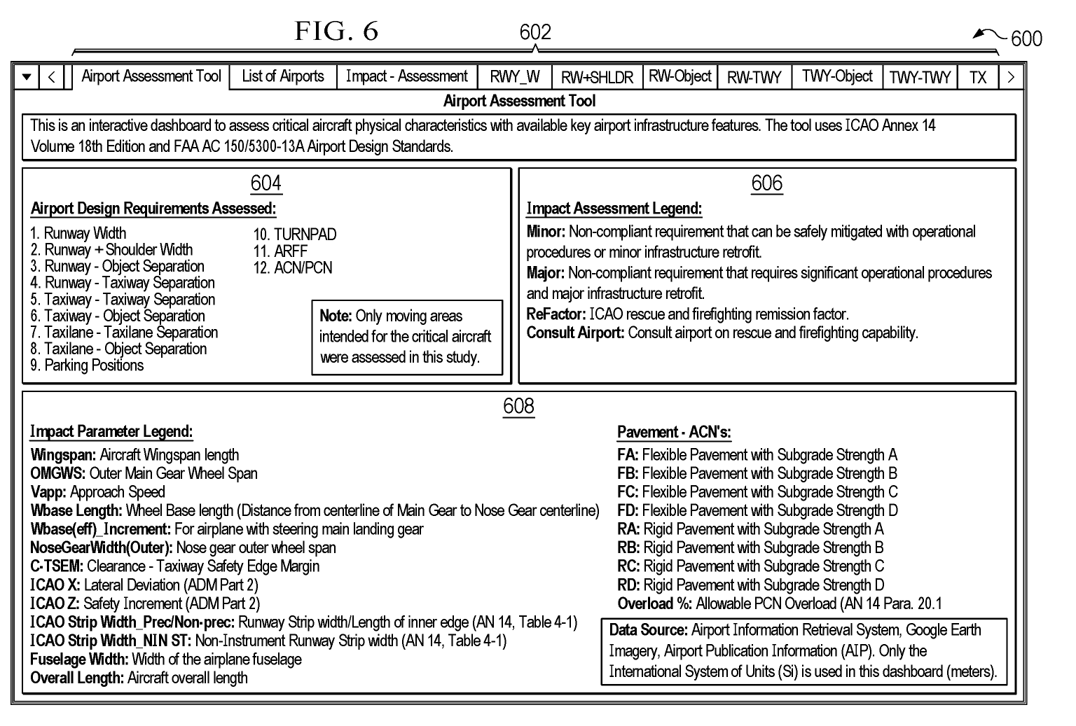

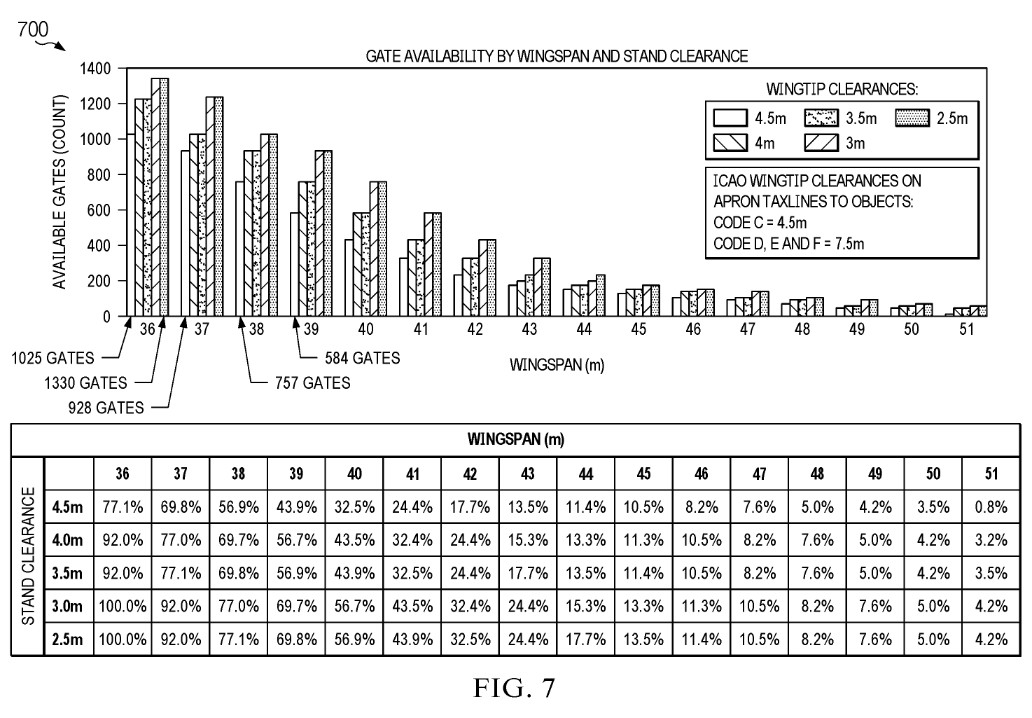

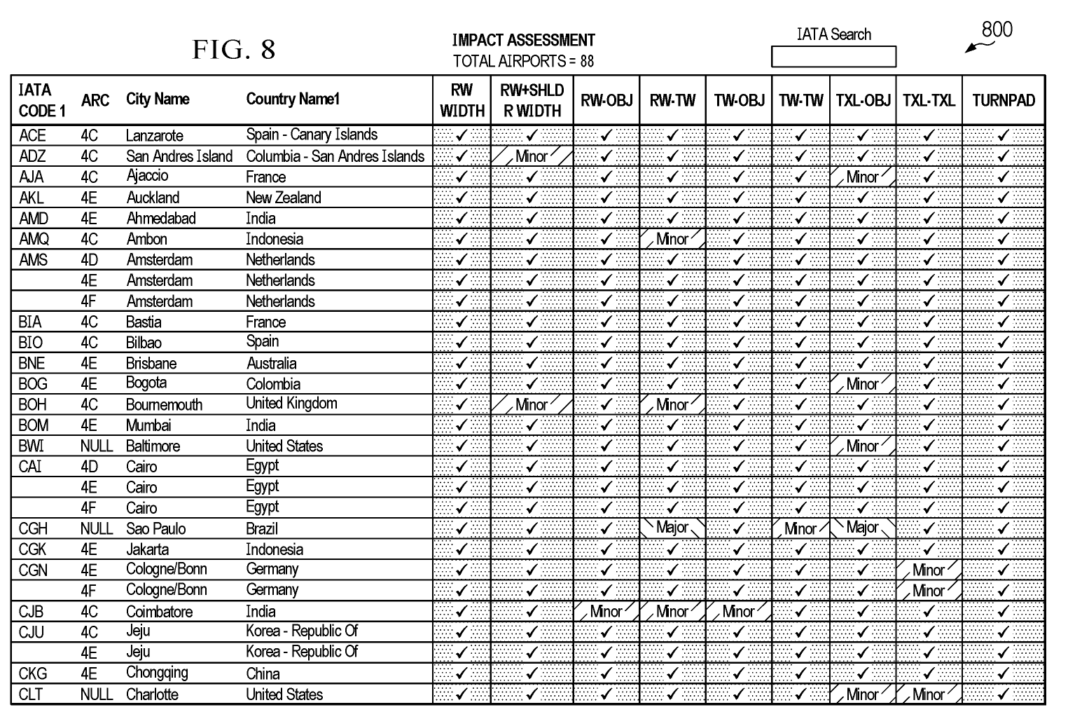

The airport compatibility system 100 provides a user interface 126 with a dashboard 128 (see FIG. 6). Dashboard 128 can display outputs generated by the airport compatibility tool 114, which can include a gate availability graph 130 (see FIG. 7) and an airport impact assessment graph 132 (see FIG. 8).

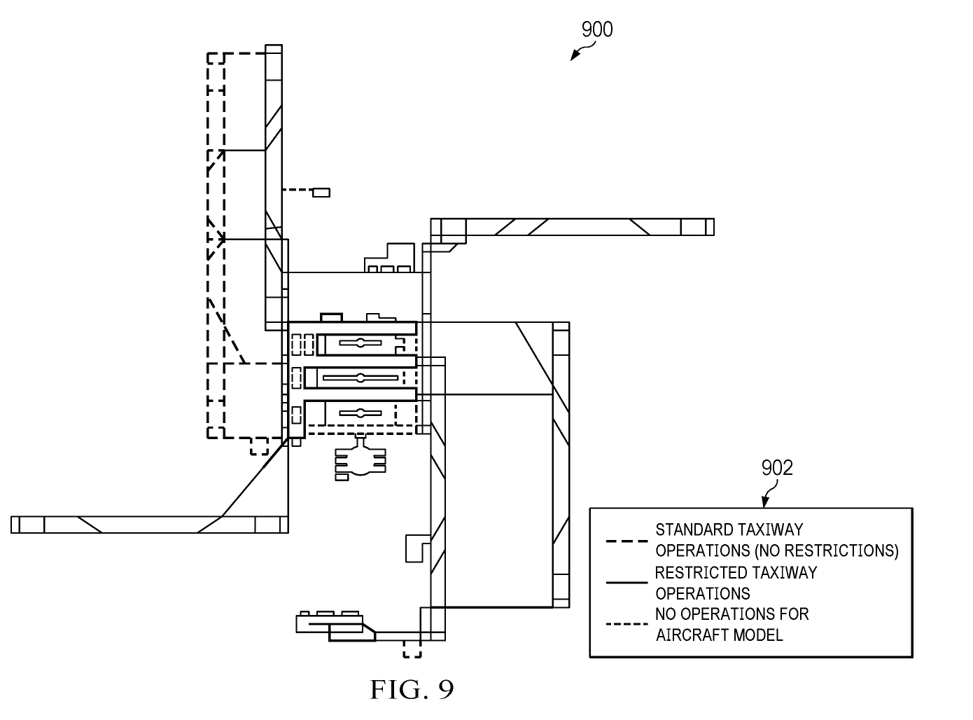

User interface 126 can also dynamically display a highlighted airport map 134 that visually designates areas of restricted and unrestricted operations for the aircraft model in question (see FIG. 9).

Airport compatibility system 100 can be implemented in software, hardware, firmware, or a combination thereof. When software is used, the operations performed by airport compatibility system 100 can be implemented in program code configured to run on hardware, such as a processor unit. When firmware is used, the operations performed by FOD detection system 100 can be implemented in program code and data and stored in persistent memory to run on a processor unit. When hardware is employed, the hardware can include circuits that operate to perform the operations in airport compatibility system 100.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 150 is a physical hardware system and includes one or more data processing systems. When more than one data processing system is present in computer system 150, those data processing systems are in communication with each other using a communications medium. The communications medium can be a network. The data processing systems can be selected from at least one of a computer, a server computer, a mobile device such as a tablet computer, or some other suitable data processing system.

As depicted, computer system 150 includes a number of processor units 152 that are capable of executing program code 154 implementing processes in the illustrative examples. As used herein, a processor unit in the number of processor units 152 is a hardware device and is comprised of hardware circuits such as those on an integrated circuit that respond and process instructions and program code that operate a computer. When a number of processor units 152 execute program code 154 for a process, the number of processor units 152 is one or more processor units that can be on the same computer or on different computers. In other words, the process can be distributed between processor units on the same or different computers in a computer system. Further, the number of processor units 152 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

FIG. 2 provides an example of an airport GIS chart mapping key airport geometry and features utilized by the illustrative embodiments. The GIS chart 200 includes airport elements such as runway, taxiway, hangers, terminal, tower, etc. However, these features have no values associated with them regarding, e.g., separation distances between runway and taxiway.

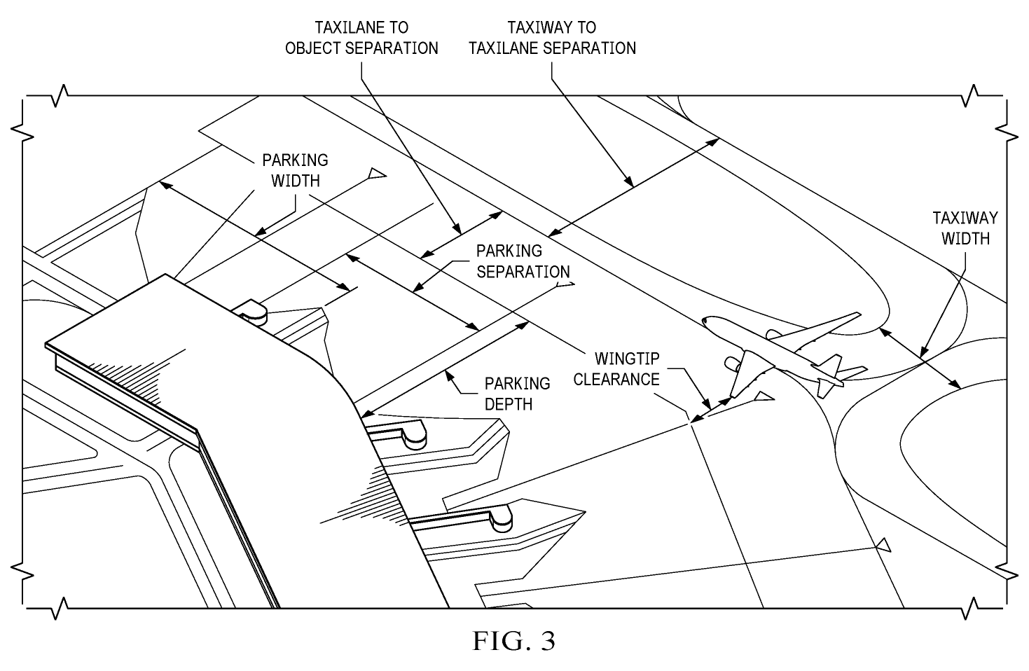

FIG. 3 depicts an illustration of airport separation categories utilized by the illustrative embodiments. Using a GIS chart (e.g., chart 200), as a starting point, the airport compatibility tool can calculate various separation distances as shown in FIG. 3, such as parking width and depth, parking separation, wingtip clearance, taxilane-to-object separation, taxiway-to-taxilane separation, taxiway width, etc.

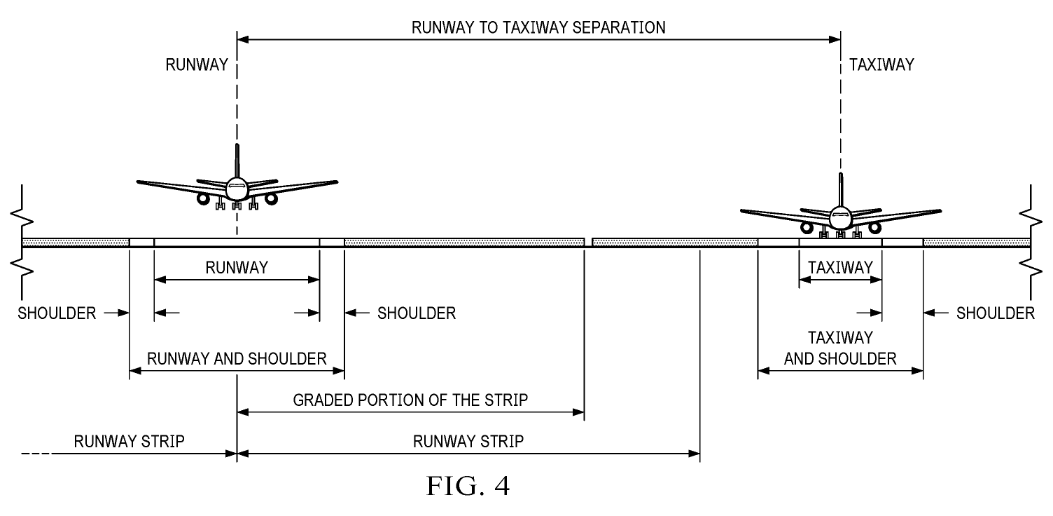

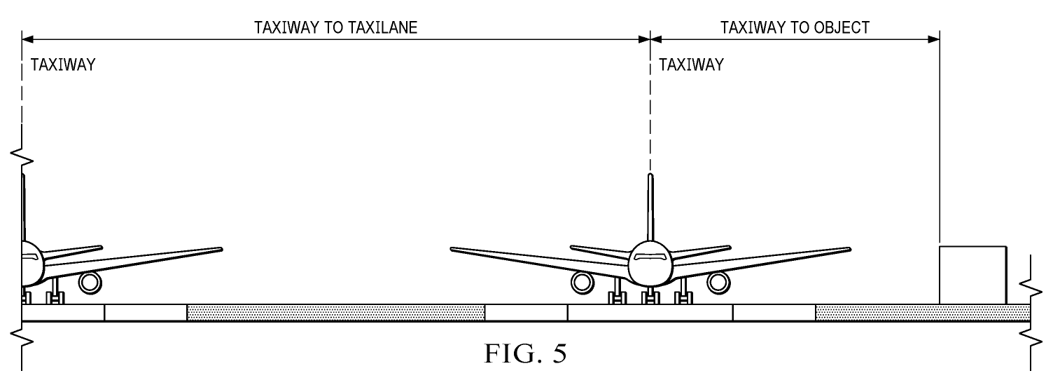

FIGS. 4 and 5 depict example ground level illustrations of the width and separation measurement categories denoted in FIG. 3 calculated by the airport compatibility tool.

FIG. 6 depicts an example dashboard for use with the airport compatibility tool in accordance with an illustrative embodiment. Dashboard 600 comprises a number of tabs 602 that a user can select to view different data and assessment results.

In the present example, the airport assessment tool tab is selected, which provided an information overview of the airport compatibility tool. Information shown in the is tab includes a list the airport design requirements assessed 604, an impact assessment legend 606, and an input parameter legend 608.

FIG. 7 depicts an example chart of available gate versus wingspan length produced by the airport compatibility tool in accordance with an illustrative embodiment. Graph 700 provides an example output of the airport compatibility tool that compares available gates across multiple airports relative to wingspan and stand clearance. This data can be used to determine the total number of gates that can accommodate different models of aircraft.

FIG. 8 depicts an example impact assessment for a number of airports in relation to a given aircraft model. Impact assessment 800 is an example of airport impact assessment chart 132 produced by the airport compatibility took 114. In this example, impact assessment 800 lists the assessment categories as columns cross-referenced with airports in the rows. For each assessment category, impact assessment 800 denotes whether the aircraft model in question is compatible with the airport in question. Areas that have minor issues are noted which require caution. As noted above, minor issues represent non-compliance that can be mitigated with adjustments to operational procedures. Areas with major issues indicate sections of the airport that will not accommodate the aircraft model in question without significant modifications to either the aircraft or airport infrastructure.

FIG. 9 depicts an example airport map color coded for compatibility with a specific aircraft model in accordance with an illustrative embodiment. Map 900 is highlighted according to legend 902. The highlights indicate areas of the airport that the aircraft model in question can perform standard taxiway operations without restrictions, areas where restricted operations are required, and areas of the airport where the aircraft model cannot be operated at all. Map 900 can be dynamically displayed on the flight deck of the aircraft to guide the flight crew in real time.

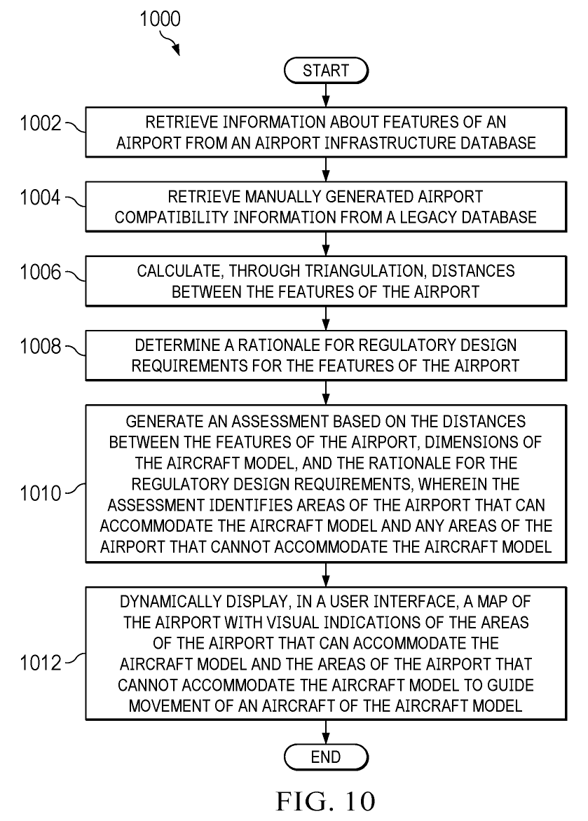

FIG. 10 depicts a flowchart illustrating a process for assessing compatibility of airport infrastructure with an aircraft model design in accordance with an illustrative embodiment. Process 1000 can be implemented in FOD detection system 100 in FIG. 1.

Process 1000 begins by retrieving information about features of an airport from an airport infrastructure database (operation 1002). Process 1000 might also retrieve manually generated airport compatibility information from a legacy database (operation 1004). The legacy database might include runway length, runway width, runway declared distances for performance calculations, runway pavement strength, airport weather, airport services, historical airport lighting strikes. From this information, process 1000 calculating, through triangulation, distances between the features of the airport (operation 1006).

Process 1000 determines a rationale for regulatory design requirements for the features of the airport (operation 1008).

Process 1000 generates an assessment based on the distances between the features of the airport, dimensions of the aircraft model, and the rationale for the regulatory design requirements (operation 1010). The assessment identifies areas of the airport that can accommodate the aircraft model and any areas of the airport that cannot accommodate the aircraft model.

The assessment might assess runway width, runway plus runway shoulder width, runway-object separation, runway taxiway separation, taxiway width plus shoulder, taxiway-object separation, taxiway-taxiway separation, taxilane-object separation, taxilane-taxilane separation, turnpad length and width, apron parking position width and length, aircraft rescue and fire fighting, ACN-PCN (aircraft classification number – pavement classification number), and ACR-PCR (aircraft classification rating – pavement classification rating).

The areas of the airport that can accommodate the aircraft model might include areas that are non-compliant with the regulatory requirements that can be mitigated with operational procedures. The areas of the airport that cannot accommodate the aircraft model might comprise areas requiring modification to either the aircraft model or the airport infrastructure to accommodate the aircraft model.

Process 1000 dynamically displaying, in a user interface, a map of the airport with visual indications of the areas of the airport that can accommodate the aircraft model and the areas of the airport that cannot accommodate the aircraft model to guide movement of an aircraft of the aircraft model (operation 1012). The map can be displayed dynamically on the flight deck of the aircraft to guide the flight crew.

Process 1000 then ends.

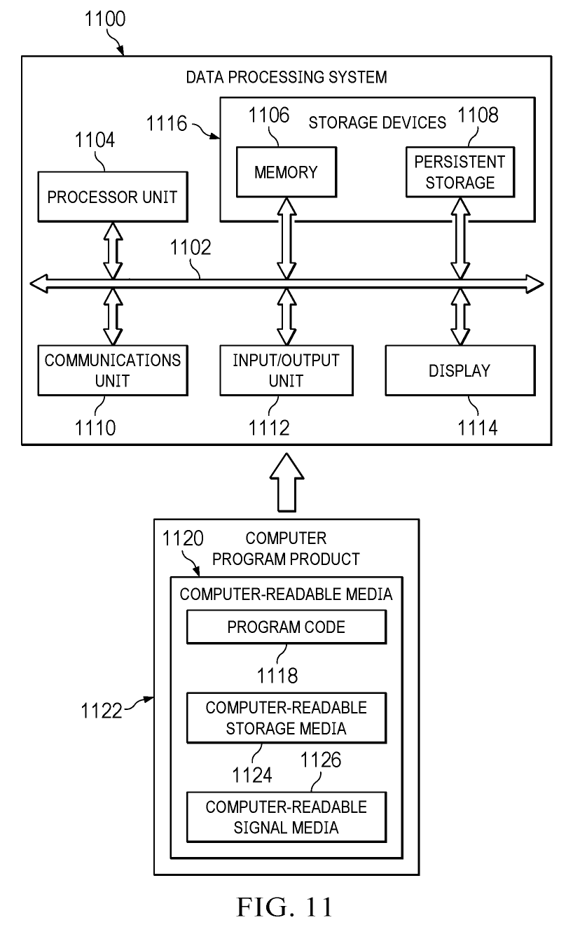

Turning now to FIG. 11, an illustration of a block diagram of a data processing system is depicted in accordance with an illustrative embodiment. Data processing system 1100 may be used to implement computer system 150 in FIG. 1. In this illustrative example, data processing system 1100 includes communications framework 1102, which provides communications between processor unit 1104, memory 1106, persistent storage 1108, communications unit 1110, input/output (I/O) unit 1112, and display 1114. In this example, communications framework 1102 takes the form of a bus system.

Processor unit 1104 serves to execute instructions for software that may be loaded into memory 1106. Processor unit 1104 may be a number of processors, a multi-processor core, or some other type of processor, depending on the particular implementation. In an embodiment, processor unit 1104 comprises one or more conventional general-purpose central processing units (CPUs). In an alternate embodiment, processor unit 1104 comprises one or more graphical processing units (GPUs).

Memory 1106 and persistent storage 1108 are examples of storage devices 1116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1116 may also be referred to as computer-readable storage devices in these illustrative examples. Memory 1106, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a flash memory, a rewritable optical disk, a rewritable magnetic tape, or some combination of the above. The media used by persistent storage 1108 also may be removable. For example, a removable hard drive may be used for persistent storage 1108. Communications unit 1110, in these illustrative examples, provides for communications with other data processing systems or devices. In these illustrative examples, communications unit 1110 is a network interface card.

Input/output unit 1112 allows for input and output of data with other devices that may be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs may be located in storage devices 1116, which are in communication with processor unit 1104 through communications framework 1102. The processes of the different embodiments may be performed by processor unit 1104 using computer-implemented instructions, which may be located in a memory, such as memory 1106.

These instructions are referred to as program code, computer-usable program code, or computer-readable program code that may be read and executed by a processor in processor unit 1104. The program code in the different embodiments may be embodied on different physical or computer-readable storage media, such as memory 1106 or persistent storage 1108.

Program code 1118 is located in a functional form on computer-readable media 1120 that is selectively removable and may be loaded onto or transferred to data processing system 1100 for execution by processor unit 1104. Program code 1118 and computer-readable media 1120 form computer program product 1122 in these illustrative examples. In one example, computer-readable media 1120 may be computer-readable storage media 1124 or computer-readable signal media 1126.

In these illustrative examples, computer-readable storage media 1124 is a physical or tangible storage device used to store program code 1118 rather than a medium that propagates or transmits program code 1118. Computer readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1118 may be transferred to data processing system 1100 using computer-readable signal media 1126. Computer-readable signal media 1126 may be, for example, a propagated data signal containing program code 1118. For example, computer-readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of different types of networks” is one or more different types of networks. In illustrative example, a “set of” as used with reference items means one or more items. For example, a set of metrics is one or more of the metrics.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for assessing compatibility of airport infrastructure with an aircraft model design, the method comprising:
using a number of processors to perform:
retrieving information about features of an airport from an airport infrastructure database;
calculating, through triangulation, distances between the features of the airport;
determining a rationale for regulatory design requirements for the features of the airport;
generating an assessment based on the distances between the features of the airport, dimensions of the aircraft model, and the rationale for the regulatory design requirements, wherein the assessment identifies areas of the airport that can accommodate the aircraft model and any areas of the airport that cannot accommodate the aircraft model; and
dynamically displaying, in a user interface, a map of the airport with visual indications of the areas of the airport that can accommodate the aircraft model and the areas of the airport that cannot accommodate the aircraft model to guide movement of an aircraft of the aircraft model.

2. The method of claim 1, further comprising retrieving manually generated airport compatibility information from a legacy database.

3. The method of claim 2, wherein the legacy database includes at least one of:
runway length;
runway width;
runway declared distances for performance calculations;
runway pavement strength;
airport weather;
airport services; or
historical airport lighting strikes.

4. The method of claim 1, wherein the assessment assesses at least one of:
runway width;
runway plus runway shoulder width;
runway-object separation;
runway taxiway separation;
taxiway width plus shoulder;
taxiway-object separation;
taxiway-taxiway separation;
taxilane-object separation;
taxilane-taxilane separation;
turnpad length and width;
apron parking position width and length;
aircraft rescue and fire fighting;
ACN-PCN (aircraft classification number – pavement classification number); or
ACR-PCR (aircraft classification rating – pavement classification rating).

5. The method of claim 1, wherein the areas of the airport that can accommodate the aircraft model include areas that are non-compliant with the regulatory requirements that can be mitigated with operational procedures.

6. The method of claim 1, wherein the areas of the airport that cannot accommodate the aircraft model comprise areas requiring modification to either the aircraft model or the airport infrastructure to accommodate the aircraft model.

7. The method of claim 1, wherein the map is displayed on the flight deck of the aircraft.

8. A system for assessing compatibility of airport infrastructure with an aircraft model design, the system comprising:
a storage device that stores program instructions;
one or more processors operably connected to the storage device and configured to execute the program instructions to cause the system to:
retrieve information about features of an airport from an airport infrastructure database;
calculate, through triangulation, distances between the features of the airport;
determine a rationale for regulatory design requirements for the features of the airport;
generate an assessment based on the distances between the features of the airport, dimensions of the aircraft model, and the rationale for the regulatory design requirements, wherein the assessment identifies areas of the airport that can accommodate the aircraft model and any areas of the airport that cannot accommodate the aircraft model; and
dynamically display, in a user interface, a map of the airport with visual indications of the areas of the airport that can accommodate the aircraft model and the areas of the airport that cannot accommodate the aircraft model to guide movement of an aircraft of the aircraft model.

9. The system of claim 8, wherein the processors further execute instructions to retrieve manually generated airport compatibility information from a legacy database.

10. The system of claim 9, wherein the legacy database includes at least one of:
runway length;
runway width;
runway declared distances for performance calculations;
runway pavement strength;
airport weather;
airport services; or
historical airport lighting strikes.

11. The system of claim 8, wherein the assessment assesses at least one of:
runway width;
runway plus runway shoulder width;
runway-object separation;
runway taxiway separation;
taxiway width plus shoulder;
taxiway-object separation;
taxiway-taxiway separation;
taxilane-object separation;
taxilane-taxilane separation;
turnpad length and width;
apron parking position width and length;
aircraft rescue and fire fighting;
ACN-PCN (aircraft classification number – pavement classification number); or
ACR-PCR (aircraft classification rating – pavement classification rating).

12. The system of claim 8, wherein the areas of the airport that can accommodate the aircraft model include areas that are non-compliant with the regulatory requirements that can be mitigated with operational procedures.

13. The system of claim 8, wherein the areas of the airport that cannot accommodate the aircraft model comprise areas requiring modification to either the aircraft model or the airport infrastructure to accommodate the aircraft model.

14. The system of claim 8, wherein the map is displayed on the flight deck of the aircraft.

15. A computer program product for assessing compatibility of airport infrastructure with an aircraft model design, the computer program product comprising:
a computer-readable storage medium having program instructions embodied thereon to perform the operations of:
retrieving information about features of an airport from an airport infrastructure database;
calculating, through triangulation, distances between the features of the airport;
determining a rationale for regulatory design requirements for the features of the airport;
generating an assessment based on the distances between the features of the airport, dimensions of the aircraft model, and the rationale for the regulatory design requirements, wherein the assessment identifies areas of the airport that can accommodate the aircraft model and any areas of the airport that cannot accommodate the aircraft model; and
dynamically displaying, in a user interface, a map of the airport with visual indications of the areas of the airport that can accommodate the aircraft model and the areas of the airport that cannot accommodate the aircraft model to guide movement of an aircraft of the aircraft model.

16. The computer program product of claim 15, further comprising instructions for retrieving manually generated airport compatibility information from a legacy database.

17. The computer program product of claim 16, wherein the legacy database includes at least one of:
runway length;
runway width;
runway declared distances for performance calculations;
runway pavement strength;
airport weather;
airport services; or
historical airport lighting strikes.

18. The computer program product of claim 15, wherein the assessment assesses at least one of:
runway width;
runway plus runway shoulder width;
runway-object separation;
runway taxiway separation;
taxiway width plus shoulder;
taxiway-object separation;
taxiway-taxiway separation;
taxilane-object separation;
taxilane-taxilane separation;
turnpad length and width;
apron parking position width and length;
aircraft rescue and fire fighting;
ACN-PCN (aircraft classification number – pavement classification number); or
ACR-PCR (aircraft classification rating – pavement classification rating).

19. The computer program product of claim 15, wherein the areas of the airport that can accommodate the aircraft model include areas that are non-compliant with the regulatory requirements that can be mitigated with operational procedures.

20. The computer program product of claim 15, wherein the areas of the airport that cannot accommodate the aircraft model comprise areas requiring modification to either the aircraft model or the airport infrastructure to accommodate the aircraft model.

21. The computer program product of claim 15, wherein the map is displayed on the flight deck of the aircraft.
